(19) United States
(12) Patent Application Publication
(10) Pub. No.: US 2024/0389141 A1
(43) Pub. Date: Nov. 21, 2024

(54) WIRELESS COMMUNICATION PROTOCOL

(71) Applicant: The University of Sydney, New South Wales (AU)

(72) Inventors: Litianyi Zhang, New South Wales (AU); Yifan Gu, New South Wales (AU); Yonghui Li, New South Wales (AU); Branka Vucetic, New South Wales (AU); Rui Wang, New South Wales (AU)

(73) Assignee: The University of Sydney, New South Wales (AU)

(21) Appl. No.: 18/691,422

(22) PCT Filed: Sep. 12, 2022
(86) PCT No.: PCT/AU2022/051102

§ 371 Date: Mar. 12, 2024

(30) Foreign Application Priority Data
Sep. 13, 2021 (AU) 2021902954

(51) Int. Cl. H04W 74/0808; H04L 5/00; H04W 84/12

(52) U.S. Cl. CPC H04W 74/0808; H04L 5/0053; H04W 84/12

(57) ABSTRACT

The present invention is concerned with a wireless device comprising: a communication processor; WiFi hardware operable to access a WiFi communication channel; and a computer-readable medium storing instructions, which when executed by the communications processor, cause the communication processor to: execute, in a MAC layer of a communication protocol stack, a channel-access scheduler that controls the WiFi hardware to access the WiFi communication channel by way of a TDMA channel-access method.

### TECHNICAL FIELD

The present invention relates to wireless communications protocols and in particular to WiFi communication protocols.

### BACKGROUND

WiFi is a family of wireless network protocols based on the IEEE 802.11 family of standards. WiFi networks are typically established by an access point (AP) to which individual wireless devices connect. The range of current WiFi networks is typically limited to the tens of metres, which thus limits the application of WiFi to either indoor environments such as homes, businesses, and offices, or geographically-constrained outdoor environments.

Longer range WiFi networks are desirable, for example to provide communications for underground environments such as underground mines and transport systems. Longer range WiFi is also desirable in aboveground settings that cover wider geographic areas, such as construction sites, agricultural and industrial environments. In principle, longer range WiFi networks are achievable through the use of APs with directional antennas. However, due to limitations that arise from current WiFi protocols (and especially the use of carrier sense multiple access (CSMA) channel-access protocols), existing APs do not establish WiFi networks using directional antennas. In this regard, CSMA protocols have poor performance with nodes that are disbursed over wide geographical areas. Nodes far away from each other cannot sense transmissions of other nodes, which leads to collisions and associated performance degradation.

This shortcoming has hitherto limited longer range WiFi connections to single point-to-point connections between fixed nodes.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY

Aspects of the present disclosure aim to provide WiFi connection protocols and/or architectures that allow for the creation of longer range WiFi networks that support multiple mobile devices. Some aspects of the present disclosure also aim to provide protocols and services for managing such long-range WiFi networks.

According to a first aspect of the present disclosure there is provided a wireless device comprising: a communication processor; WiFi hardware operable to access a WiFi communication channel; and a computer-readable medium storing instructions, which when executed by the communications processor, cause the communication processor to: execute, in a MAC layer of a communication protocol stack, a channel-access scheduler that controls the WiFi hardware to access the WiFi communication channel by way of a TDMA channel-access method.

In some embodiments, by substantially eliminating the occurrence of collisions from hidden nodes in conventional CSMA networks, aspects of the present disclosure provide a protocol that allows the establishment of robust, long-range WiFi networks. Such networks can be readily deployed in a wide range of environments including underground mining environments, aboveground construction and many large industrial settings.

In turn, with the proposed protocol, WiFi networks can be established to operate over larger geographical areas, so less APs are needed, thus lowering the overall infrastructure cost.

In addition, aspects of the present disclosure can be implemented using existing WiFi hardware and chipsets, and is also compatible with existing WiFi networks.

According to one embodiment. the channel-access scheduler operates according to scheduling instructions, the scheduling instructions defined in a network data unit received by the wireless device over the WiFi communication channel.

Preferably, the instructions further cause the communication processor to: transmit a packet during a communication time slot allocated to the wireless device by the channel-access scheduler; determine whether an acknowledgment packet is received at the wireless device within a predetermined time; and in the absence of receipt of an acknowledgement packet within a predetermined time, retransmitting the packet during two or more communication time slots allocated to the wireless device by the channel-access scheduler.

According to one embodiment, the instructions further cause the communication processor to: receive two or more frames over the WiFi communication channel; aggregate the received frames into an aggregated frame; and transmit the aggregated frame over the WiFi communication channel to multiple stations using a broadcast address.

The communication processor may aggregate the received frames by: utilising the destination address of a first frame as the broadcast address; appending an aggregation identifier to the broadcast address; appending a first station flag to the aggregation identifier; appending the first frame to the aggregation identifier; appending a second station flag to the first frame; and appending a second frame to the second station flag.

According to one embodiment, the instructions further cause the communication processor to: parse a frame received at the wireless device and determine whether the frame is an aggregated frame; and in the event that the frame is an aggregated frame, de-aggregate the aggregated frame.

In some embodiments, the communications processor determines whether the frame is an aggregated frame by parsing the frame for a broadcast address and an aggregation identifier.

The communication processor may de-aggregate a frame by identifying a network address in the frame and discarding the remainder of the frame after the network address.

In other embodiments, the instructions further cause the communications processor to apply a restricted access mechanism in which the wireless device accesses the TDMA wireless communication channel only during a restricted access window.

Optionally, the instructions further cause the communications processor to allow the wireless device to access a CSMA wireless communication network during times outside the restricted access window.

According to a second aspect of the present disclosure there is provided a method executable on a WiFi access point, the method comprising: executing, in a MAC layer of a communication protocol stack installed on the WiFi access point, a channel-access scheduler that controls the WiFi access point to access the WiFi communication channel by way of a TDMA channel-access method.

Preferably, the WiFi access point is operably connected to a directional antenna, the channel-access scheduler controlling the WiFi access point to access the WiFi communication channel using the directional antenna.

According to one embodiment. the channel-access scheduler operates according to scheduling instructions, the scheduling instructions generated by the WiFi access point or received by the WiFi access point over the WiFi communication channel.

Preferably, the method further includes the WiFi access point: transmitting a packet during a communication time slot allocated to the WiFi access point by the channel-access scheduler; determining whether an acknowledgment packet is received at the WiFi access point within a predetermined time; and in the absence of receipt of an acknowledgement packet within a predetermined time, retransmitting the packet during two or more communication time slots allocated to the WiFi access point by the channel-access scheduler.

According to one embodiment. the method further includes the WiFi access point: receiving two or more frames over the WiFi communication channel; aggregating the received frames into an aggregated frame; and transmitting the aggregated frame over the WiFi communication channel to multiple stations using a broadcast address.

The WiFi access point may aggregate the received frames by: utilising the destination address of a first frame as the broadcast address; appending an aggregation identifier to the broadcast address; appending a first station flag to the aggregation identifier; appending the first frame to the aggregation identifier; appending a second station flag to the first frame; and
appending a second frame to the second station flag.

According to one embodiment, the method further includes the WiFi access point: parsing a frame received at the WiFi access point and determining whether the frame is an aggregated frame; and in the event that the frame is an aggregated frame, de-aggregating the aggregated frame.

The WiFi access point may determine whether the frame is an aggregated frame by parsing the frame for a broadcast address and an aggregation identifier.

The WiFi access point may de-aggregate a frame by identifying a network address in the frame and discarding the remainder of the frame after the network address.

According to one embodiment. the method further includes the WiFi access point applying a restricted access mechanism in which wireless devices are permitted to access the TDMA wireless communication network only during a restricted access window.

Preferably, the method further includes the WiFi access point permitting wireless devices to access a CSMA wireless communication network during times outside the restricted access window.

According to a third aspect of the present invention, there is provided a computer readable medium storing instructions, which when executed by a communications processor, cause the communications processor to execute, in a MAC layer of a communication protocol stack, a channel-access scheduler that controls WiFi hardware to access a WiFi communication channel by way of a TDMA channel-access method.

Preferably, the computer readable medium includes instructions that further cause the communication processor to: transmit a packet during a communication time slot allocated to the wireless device by the channel-access scheduler; determine whether an acknowledgment packet is received at the wireless device within a predetermined time; and in the absence of receipt of an acknowledgement packet within a predetermined time, retransmitting the packet during two or more communication time slots allocated to the wireless device by the channel-access scheduler.

According to one embodiment. the computer readable medium includes instructions that further cause the communication processor to: receive two or more frames over the WiFi communication channel; aggregate the received frames into an aggregated frame; and transmit the aggregated frame over the WiFi communication channel to multiple stations using a broadcast address.

The communication processor may aggregate the received frames by: utilising the destination address of a first frame as the broadcast address; appending an aggregation identifier to the broadcast address; appending a first station flag to the aggregation identifier; appending the first frame to the aggregation identifier; appending a second station flag to the first frame; and appending a second frame to the second station flag.

According to one embodiment. the computer readable medium includes instructions that further cause the communication processor to: parse a frame received at the wireless device and determine whether the frame is an aggregated frame; and in the event that the frame is an aggregated frame, de-aggregate the aggregated frame.

In some embodiments, the communications processor determines whether the frame is an aggregated frame by parsing the frame for a broadcast address and an aggregation identifier.

The communication processor may de-aggregate a frame by identifying a network address in the frame and discarding the remainder of the frame after the network address.

In other embodiments, the computer readable medium includes instructions that further cause the communications processor to apply a restricted access mechanism in which wireless devices are permitted to access the TDMA WiFi communication channel only during a restricted access window.

Optionally, the computer readable medium includes instructions that further cause the communications processor to allow wireless devices to access a CSMA WiFi communication channel during times outside the restricted access window.

According to a further aspect of the present invention, there is provided a long range WiFi network, comprising: a WiFi access point according to the second aspect of the invention; a directional antenna communicatively coupled to the WiFi access point; and one or more wireless devices each including the computer readable medium according to the third aspect of the present invention.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

An embodiment of the present invention will be described by reference to the following drawings, in which;

FIG. 1 is a schematic illustration of a WiFi network established using the WiFi communication protocol according to an embodiment of the present invention.

FIG. 2 is a block diagram illustrating a software architecture for a wireless device to communicate using the protocol according to an embodiment of the present invention.

FIG. 3 is a network communication sequence diagram illustrating a wireless device connecting to a WiFi network established using the WiFi communication protocol according to an embodiment of the present invention.

FIG. 4 is block diagram of a Superframe according to an embodiment of the present invention.

FIG. 5 is a flow chart illustrating processing operations performed by a station or an AP when implementing the communication protocol defined by the Superframe illustrated in FIG. 4.

FIG. 6 is a flow chart illustrating processing operations performed by a station or an AP to effect frame aggregation according to an embodiment of the present invention.

FIG. 7 is a block diagram of an aggregated frame according to an embodiment of the present invention.

FIG. 8 is a block diagram of a frame and communication structure of a hybrid CSMA/TDMA communication protocol according to an embodiment of the present invention.

FIGS. 9 to 13 are various graphs depicting the results of experiments performed on the communication protocol according to an embodiment of the present invention.

FIG. 14 is a block diagram of a computer processing system suitable for executing communication protocols according to embodiments of the present invention.

### DETAILED DESCRIPTION

Further aspects of the present invention and further embodiments of the aspects described in the preceding paragraphs will become apparent from the following description, given by way of example and with reference to the accompanying drawings.

The exemplified embodiments of the present disclosure provide long-range WiFi links based on commercial off-the-shelf (COTS) hardware for environments including industrial, underground and aboveground mining, construction and agricultural environments.

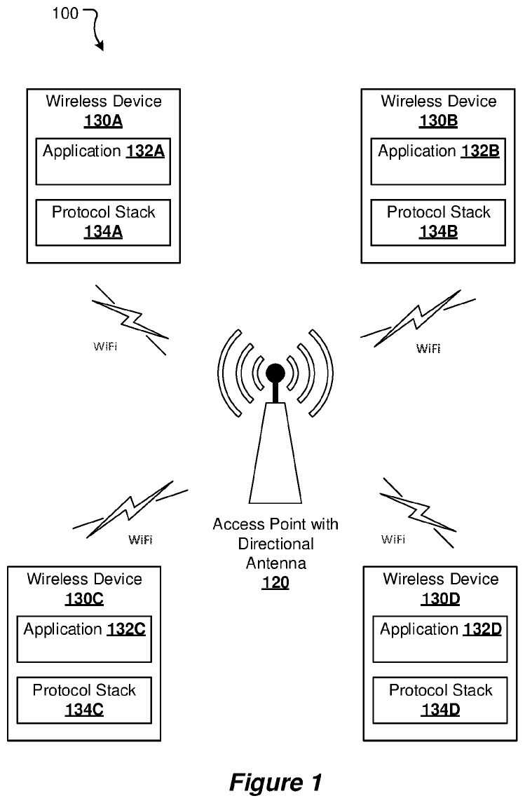

FIG. 1 schematically illustrates an example of an environment 100 in which an embodiment of the present disclosure is implemented. Environment 100 includes a WiFi access point (AP) 120. AP 120 includes the necessary computational hardware (namely processor, RAM, and secondary storage), networking hardware (namely WiFi adapter and modem chipset) and software in order for it to provide WiFi access to connected devices. In this regard, AP 120 includes a directional antenna for transmitting and receiving WiFi signals.

The choice of directional antenna is influenced by the installation environment 100. For example, industrial and agricultural applications can require longer radiation distances (e.g., more than 1000 meters) and larger coverage angles (e.g., between 18 to 120 degrees). The HUAWEI® Dual-Polarized Directional Antenna 27010898, with a 370 m radiation distance and 65 degrees horizontal lobe width is suitable in this regard, particularly in agricultural environments where mobile devices are distributed across a relatively large area. In other industrial applications such as underground mining, narrower radiation angles may be preferred. The Tupavco TP511 high-gain directional antenna, with 18 degrees horizontal lobe width and radiation distance of over one km is an example of a directional antenna suitable for mining tunnels where a narrow radiation angle is required.

For the purpose of illustration, environment 100 includes four wireless devices 130A, 130B, 130C, and 130D, however those skilled in the art will appreciate that potentially many more wireless devices can be utilised with the exemplified embodiments of the present invention. Wireless devices 130A, 130B, 130C and 130D are computing devices such as laptop computers, smart phones, tablets, wearable computers, IOT devices, scanners, and/or devices integrated into mining or construction machinery.

In this specification, the term “wireless device” is used interchangeably with the term “station.” Each wireless device 130A, 130B, 130C, and 130D executes an application 132A, 132B, 132C, and 132D relevant to the installation environment. For example, in the mining environment, applications 132A, 132B, 132C, and 132D may be a mine environment-monitoring and safety application. Applications 132A, 132B, 132C, and 132D execute on top of a respective communication protocol stack 132A, 132B, 132C, and 132D that provides network communication services to the applications.

Wireless devices 130A, 130B, 130C, and 130D are each communicatively coupled to the AP 120 by way of a WiFi radio communication channel. In the illustrated embodiment, the wireless devices 130A, 130B, 130C and 130D, and the AP 120 form a star topology.

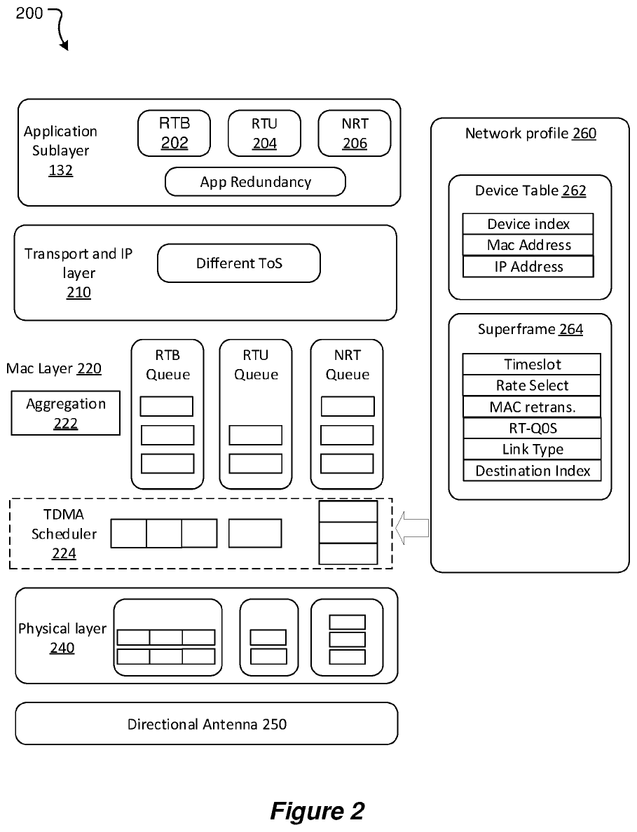

FIG. 2 is a schematic illustration of the software architecture 200 of the wireless devices 130A, 130B, 130C and 130D, and AP 120. As noted above, an Application sublayer 132 executes on top of a protocol stack, which in FIG. 2 comprises a Transport & IP Layer 210, a MAC Layer 220, and a Physical Layer 240. The Physical Layer 240 in the illustrated embodiment is the IEEE 802.11 layer.

Architecture 200 is operably coupled to an antenna 250. For the wireless devices 130A, 130B, 130C, and 130D, antenna 250 is an omnidirectional antenna, whereas for the AP 120, as described above, the antenna 250 is a directional antenna.

In the exemplified architecture, the following communication modules execute on the Application sublayer 132:
RTB—Real-time data transmissions through aggregation and broadcast.
RTU—Real-time data transmissions through unicast; and
NRT—Non-real-time transmissions within a Non-realtime Window (NRTW)

As described in further detail below, the RTB, RTU, and NRT modules provide communication and Quality-of-Service (QOS) functionalities to the Application Sublayer132.

An App Redundancy module is also provided in the Application Sublayer 132.

The Transport and IP Layer 210 is an orthodox TCP/IP protocol layer and includes a data structure with a field for defining various types of services in an IP header.

At the MAC Layer 220, there is an Aggregation Module 222 and a TDMA Scheduler 224. As described in further detail below, the Aggregation Module 222 aggregates multiple RTB frames into an aggregated frame. which is transmitted by way of an RTB broadcast.

The TDMA Scheduler 224 is responsible for controlling the WiFi hardware in the physical layer 240 to access the WiFi communication channel (to transmit and receive frames thereon) using a TDMA channel access method. Those skilled in the art will appreciate that TDMA (or ‘time-division multiple access) is a channel access method for shared-medium networks that allows several users to share the same frequency channel by dividing the signal into different time slots. The users transmit in rapid succession, one after the other, each using its own time slot.

The access scheme that the TDMA Scheduler 224 provides is implemented at the MAC layer 220 and is thus compatible with essentially any commercial WiFi directional antennas. In this regard, the TDMA Scheduler 224 sits atop an orthodox WiFi physical layer 240.

In the illustrated embodiment, MAC layer 220 frames are labelled ‘Q’. As noted above, the present invention provides a Quality-of-Service mechanism that designates frames as either RTB frames (QRTB in FIG. 2), RTU frames (QRTU in FIG. 2) or NRT frames (QNRT in FIG. 2).

Architecture 200 includes a stored Network Profile 260 relevant to the WiFi network created by the AP 120. The Network Profile 260 includes a Device Table 262 that stores various network and device identifiers. In the illustrated embodiment, the Device table 262 stores a Station index, MAC Address and IP Address.

The Network Profile 260 also stores a data structure described hereinafter as a Superframe 264. As described in further detail below. the Superframe 264 stores various parameters that are used to implement the communication protocols and Application Services of the present invention. In this regard, the exemplified Superframe 264 stores data pertaining to: Timeshot, Rate Selection, MAC Retransmission, RT-QoS, Link Type, and Destination Index.

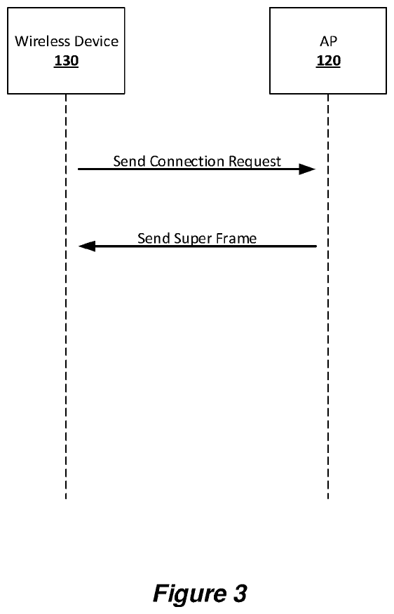

As illustrated in FIG. 3, when a wireless device 130 requests to join the Wi-Fi network established by the AP 120, the wireless device 130 first transmits a connection request to the AP 120. The connection request includes identifying details of the wireless device 130 and an indication of the required QoS. Upon receipt of the connection request, the AP 120 processes the data in the connection request and generates an applicable Superframe 264 that stores the pertinent communication and service data. The AP 120 broadcasts the Superframe 264 to all connected wireless devices, including the wireless device 130 that requested to join the network. As described in further detail below, the wireless device (and in particular the TDMA scheduler 224 and Aggregation Module 222) utilises the Superframe 264 to communicate data on the WiFi network.

As described previously, architecture 200 implements a TDMA channel allocation system, in which AP 120 allocates dedicated time slots for each wireless device 130A, 130B, 130C, and 130D to transmit its packets, thus avoiding collisions associated with CSMA channel allocation methods.

The TDMA-based system applies stringent time synchronization among all wireless devices. To perform global synchronization (namely synchronization across the entire WiFi network), each wireless device 130A, 130B, 130C, and 130D utilises the 802.11 Timing Synchronization Function (TSF) to maintain a local TSF timer synchronized to the AP 120. The TSF timer is also used to trigger device communication during the allocated TDMA slots. Synchronization of the TSF timer between the wireless devices and the AP 120 is maintained by periodically polling 802.11 beacon frames.

The TDMA scheduler 224 also ensure that the wireless devices access the WiFi channel in a centralized manner.

In this regard, many new applications that require low latency and high reliability, e.g., localization, monitoring and control applications, are emerging in the next generation of industrial systems. However, the existing CSMA access mechanism of WiFi cannot support the stringent requirements of such applications due to stations accessing the WiFi channel in a randomized manner. In contrast, the TDMA-based system according to the present embodiment, provides low latency and high reliability due to the stations accessing the WiFi channel in a deterministic manner. As described below, the present embodiment further improves latency and reliability through application-layer retransmission with error control coding (APP-Re), the QoS mechanism, and the fine-grained frame aggregation system.

The Superframe 264 defines the channel access of different wireless devices for a given time slot. In this regard, the Superframe 264 is a sequence of consecutive timeslots with parameters indicating the access of different stations. Each transmission in the Superframe 264 is configured with a link type (i.e., downlink or uplink), index of the targeted destination, a fixed transmission rate, MAC-layer retransmission times, and a Real-Time Quality-of-Service (RT-QoS) indicator. The Superframe 264 is maintained in the network profile by both the AP 120 and all wireless devices 130.

The RT-QoS (implemented by the TDMA scheduler 224) indicator, isolates packets with various requirements and imposes different transmission patterns. The RT-QoS indicator also guarantees the performance of time-critical messages even along the long-range link of the present embodiment.

The TDMA Scheduler 224 attaches a RT-QoS value to each packet in order to distinguish different traffic classes. This in turn leads to a variety of MAC layer 220 transmission patterns. The RT-QOS value uses the existing “type of service” (ToS) field found in an IP header. Users can determine a ToS value for each frame classified to a specific AC value on the MAC layer 220.

The wireless devices 130 and AP 120 both host a first-in-first-out (FIFO) queue system for each RT-QoS type. This allows the wireless devices 130 and AP 120 to maintain a cache of frames of each RT-QoS type.

As noted above, in the present embodiment, there are three types of RT-QoS, namely:

RTB 202: Real-time data transmissions through aggregation and broadcast.

RTU 204: Real-time data transmissions through unicast.

NRT 206: Non-real-time transmissions within the Non-realtime Window (NRTW).

According to the present embodiment, an RT-QoS indicator is defined for each timeslot in the Superframe 264. This allows the stations and AP to select packets for transmission from the appropriate queue.

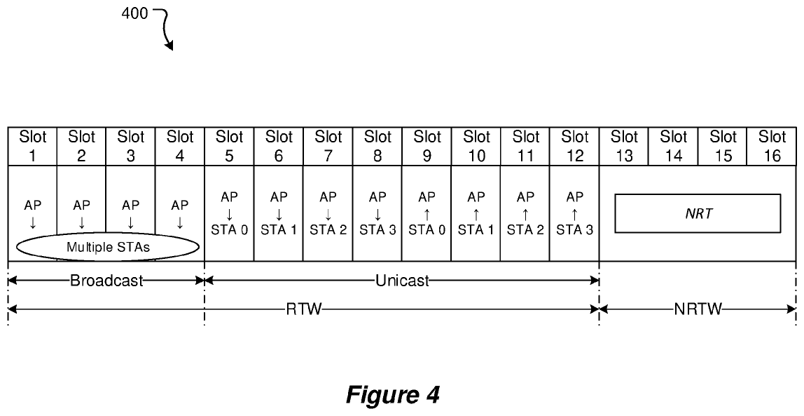

An example Superframe 264 in accordance with an embodiment of the present invention is illustrated in FIG. 4. In this example, Superframe 264 demarcates 16 TDMA scheduling timeslots—Slots 1-16. In the illustrated embodiment, these time slots are grouped into three different transmission windows. The first twelve time slots comprise the Real time Window (RTW), which is used for RTB and RTU packets. The RTW is further subdivided, with the first four timeslots thereof used for RTB packets 202. As described in further detail below, due to the frame aggregation mechanism of the present embodiment, RTB packets 202 can be transmitted through multiple time slots.

Timeslots 5 to 12 are reserved for RTU packets 204, including for both uplink and downlink transmissions. Due to full compatibility with RTB packets 202, RTB packets are permitted to be transmitted during timeslots reserved for RTU 204, but are transmitted through unicast, rather than broadcast.

Timeslots 13 to 16 are in the non-real-time window (NRTW) and are used to transmit NRT packets 206. The transmission scheme in the NRTW is best-effort, in which the wireless devices 130 and/or AP 120 transmit as many packets as possible within the allotted timeslots. This scheme is suitable for high-throughput transmissions, such as management frames and video data flow. In the best-effort scheme, the wireless devices/AP fetches a first packet from the NRT queue (Q_{NRT} in the mac layer 220) and estimate the maximum time that is required to transmit the packet. The transmitter can reserve this duration for each packet in the NRT queue and trigger transmission of the next packet as soon as the time period has expired.

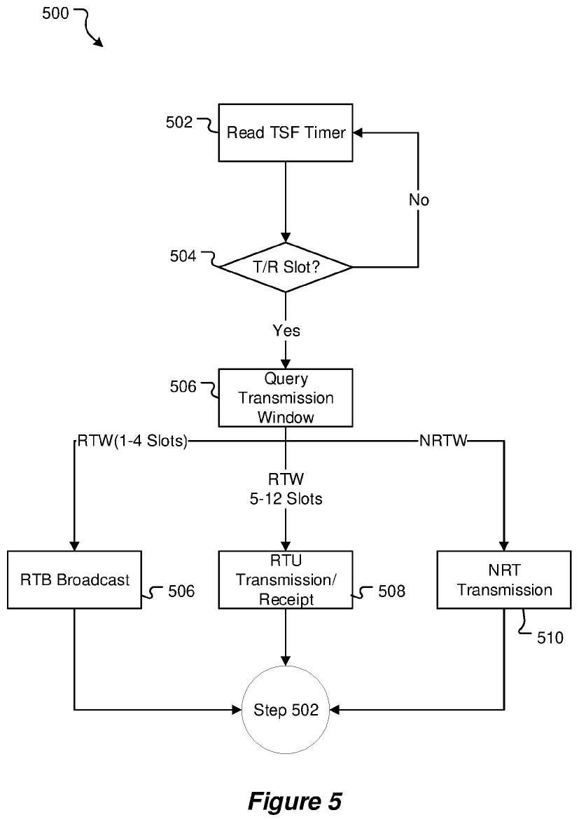

An example of the processing operations 500 performed by a wireless device 130 or AP 120 when implementing the Superframe 264 is illustrated in FIG. 5.

At step 502, the wireless device/AP receives 802.11 beacon signals and reads the TSF timer to determine which timeslot is the current timeslot.

At step 504, the wireless device/AP determines whether the current timeslot is a timeslot in which the wireless device/AP is permitted to either transmit or receive data packets. The process returns to step 502 in the event that the station/AP is not permitted to transmit or receive data.

In the event that the wireless device/AP is permitted to transmit or receive in the current timeslot, at step 506, the wireless device/AP queries the TDMA scheduler 224 and determines which transmission window in the superframe 264 is currently open. When the RTW is open, and the current timeshot is one of timeslots 1-4, the AP 120 performs an RTB broadcast to multiple wireless devices 130. An RTB broadcast is described in further detail below.

When the RTW is open, and the current timeslot is one of timeslots 5-12, the AP/wireless devices perform one of the following unicast transmissions of either RTB 202 or RTU 204 packets:
Slot 5: AP transmits to station 0;
Slot 6: AP transmits to station 1;
Slot 7: AP transmits to station 2;
Slot 8: AP transmits to station 3;
Slot 9: Wireless device 0 transmits to AP;
Slot 10: Wireless device 1 transmits to AP;
Slot 11: Wireless device 2 transmits to AP;
Slot 12: Wireless device 3 transmits to AP

Those skilled in the art will appreciate that other data communication patterns can be performed in the RTW.

When the NRTW is open, the wireless devices/AP perform continuous packet transmission using the best-effort transmission protocol described above.

Existing MAC-layer retransmissions are performed in-slot, in which a re-transmission is executed in the same slot if the sender does not receive an ACK packet from the receiver. However, in the long-range TDMA-based WiFi system of the current embodiment (without carrier sense), these MAC-layer retransmissions may fail when burst interference exists.

To address this issue, the present embodiment provides an Application level re-transmission system. The re-transmission system efficiently avoids burst interference and improves reliability by retransmitting packets at different time instants. Throughput can be limited when the distance between the transmitter and receiver is large. However, this is addressed through the application-level re-transmission system. The system serves as an error control coding scheme that reduces the amount of data needed to be transmitted in the physical layer.

The present embodiment further provides a system for fine-grained aggregation of packets. As described below, the aggregation system aggregates messages towards different stations into one frame and broadcasts the aggregated frame to all involved stations. This can reduce overhead and increase long-range transmission efficiency.

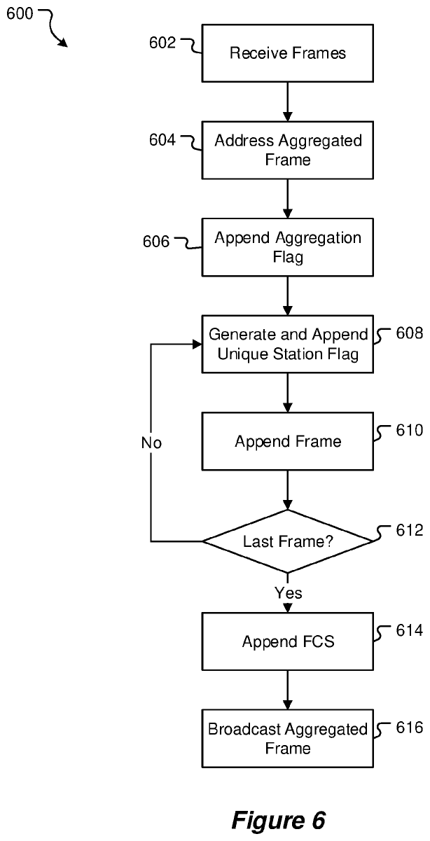

The processing steps 600 performed by a wireless device/AP to effect frame aggregation are illustrated in FIG. 6.

At step 602 the wireless device/AP receives multiple frames over the WiFi communication channel.

At step 604, the wireless device/AP creates an empty Aggregated Frame and addresses the Aggregated Frame. The station/AP addresses the Aggregated Frame by setting the destination index to a broadcast symbol, e.g., 0xFF. The MAC header of the first frame is used as the MAC header of the aggregated packet, and 0xFF is the broadcast address used as the destination address in MAC header.

At step 606, the wireless device/AP appends a one-byte hexadecimal aggregation flag after the Mac header.

At step 608, the wireless device/AP generates a unique station flag for the current frame. The unique station flag includes the identity of the station as recorded in the Device Table and a frame length.

At step 610, the wireless device/AP appends the current frame to the Aggregated Frame.

At step 612, the wireless device/AP determines whether the current frame is the last frame to be included in the Aggregated Frame. The process returns to step 608, at which the wireless device/AP generates a unique station flag for the next frame that is to be added to the Aggregated Frame.

In the event that the current frame is the last frame to the added to the Aggregated Frame, the wireless device/AP appends the frame check sequence (FCS) from the first frame to the end of the Aggregated Frame (step 614).

At step 616, the wireless device/AP transmits the Aggregated Frame. When the wireless device/AP transmits the Aggregated Frame (namely performs an RTB broadcast), the scheduler searches packets for different stations in the RTB queue. If there are two packets addressed to the one destination, the scheduler selects for transmission the packet which entered the queue earlier. Prior to broadcast, the selected packets are pushed into a temporal singly linked list.

Due to the structure of the Aggregated Frame, the first frame in the linked list retains slices of the MAC header and the frame check sequence (FCS). The final step before broadcast of the Aggregated Frame is the station/AP changing the destination address at the MAC header to the broadcast MAC address.

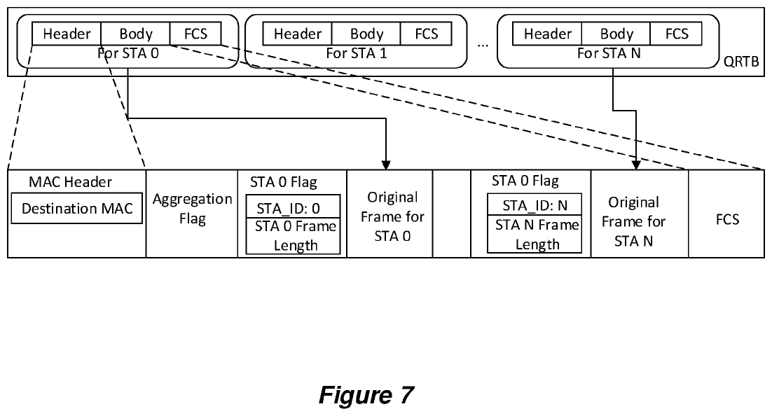

An example structure of an Aggregated Frame is illustrated in FIG. 7.

Upon receipt of an Aggregated Frame at a wireless device or AP, the wireless device/AP performs a disaggregation operation on the Aggregated Frame. To disaggregate the Aggregated Frame, the wireless device/AP first determines whether the frame is indeed aggregated. The wireless device/AP performs the determination by:
1) analysing whether the destination MAC address is a broadcast address;
2) analysing whether the octet after the MAC header is the aggregation flag.

After determining that the frame is an Aggregated Frame, the wireless device/AP commences reading the Aggregated Frame from the aggregation flag to the end of the frame. Once the station identity in the station flag is matched with its own identity, the wireless device/AP retains the immediately-following frame of the frame length recorded in the station flag. The rest of the Aggregated Frame is discarded. If the station identity is not matched, the wireless device/AP skips the frame length recorded in the station flag and commences reading the next station flag until the end pointer of the Aggregated Frame.

Existing WiFi infrastructure may generate interference to devices operating on the long-range WiFi networks according to the present disclosure. The present disclosure provides a restricted access mechanism to ameliorate such interference and thus enable long range WiFi devices and AP to be compatible with existing WiFi networks.

The restricted access mechanism utilises the network allocating vector (NAV) that is a feature of existing WiFi protocols. The restricted access mechanism defines the following two access windows:
A restricted access window for the TDMA-based access; and
An unrestricted window for the conventional CSMA access.

The restricted access mechanism modifies the NAV of the WiFi beacon frame. Conventional WiFi devices are not permitted to transmit packets during the restricted access window. Consequently, long-range devices can execute the TDMA-based transmissions discussed above during the restricted window without risk of collisions from existing WiFi infrastructure.

During the unrestricted window, existing WiFi devices are permitted to only access the WiFi communication channel using CSMA.

The restricted access mechanism also provides a hybrid CSMA/TDMA access mechanism which provides compatibility and inter-communication between long-range and conventional WiFi devices. To illustrate compatibility, for example, four types of devices can coexist in a hybrid system, namely a long-range AP and a long-range station both utilising TDMA, and a conventional AP and conventional station both utilising CSMA. Those skilled in the art will appreciate that communication between the conventional AP and wireless device can be realized through CSMA, and communication between the long-range AP and wireless device likewise realized through the above-described TDMA-based protocol stack.

For communication between conventional and long-range devices, the wireless device first determines whether it is associated with a long-range or conventional AP. The wireless device performs this determination by querying the vendor-specific field in a received WiFi beacon frame. When a long-range wireless device moves to an area covered by the long-range AP, controlling software switches the wireless device to the TDMA mode and uses the time slots allocated by the AP (as described above) to execute transmission.

Otherwise, when the wireless device reaches an area covered by a conventional AP, controlling software causes the station to adopt CSMA to access the WiFi channel.

A conventional WiFi wireless device can also be configured to communicate with both a long-range and a conventional AP by using CSMA within the unrestricted window.

It will be realised that the restricted window and hybrid CSMA/TDMA mechanisms allow the TDMA-based WiFi protocol described above to be compatible with existing WiFi infrastructure.

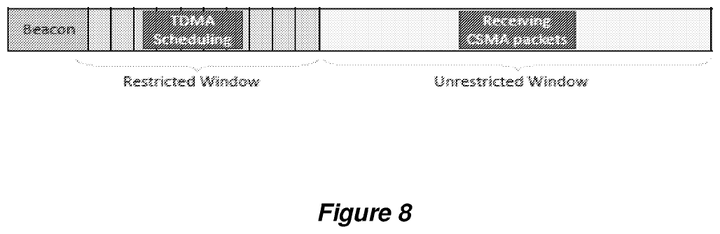

The frame and communication structure of the restricted access and hybrid CSMA/TDMA mechanisms is illustrated in FIG. 8.

The present embodiment focuses on a MAC layer design of a centralized TDMA-based protocol stack for long-range applications that substantially eliminates collisions that result from hidden node problems. Long-range WiFi communication is achieved by employing the present embodiment with commercial high-gain directional antennas.

The inventors tested the present embodiment with a Tupavco TP511 20 dBi 18° high gain directional antenna and achieved a multiple Mbps data rate in a greater than 1 km transmission range without collisions. MiniPCs from Qotom were used as AP and stations in the tests. The miniPCs ran the Ubuntu 14.04 operating system, with a Linux kernel version 3.13.0-32. For the IEEE 802.11 interface, the Atheros NIC AR9285 was used with an open-source driver ATH9k. In the following described experiments, the performance of the centralized TDMA-based protocol stack was compared with the conventional WiFi in the lab environment.

The CSMA mechanism cannot realistically be applied with directional antennas due to an inability to sense channel status in a long-range wireless link. The TDMA-based protocol described above can address this challenge by allocating a specific time slot for the channel access of each station to avoid such collisions. The throughput of the WiFi stations experiencing the hidden node problem decreases significantly, reaching almost zero. In contrast, the centralized TDMA-based WiFi protocol can eliminate to essentially zero, the collisions from hidden node problems.

### Experiments

Experiments were performed to study the hidden node scenario and measure the average throughput of different stations. Two stations and one AP were connected in a network. To study the hidden node scenario, the stations were located at two RF-shielding spaces and communicated with a reduced transmission power of 12 dbm such that neither of them could sense the other. Each station's physical transmission rate was set to 18 Mb/s, with a timeslot duration of 1 ms. The stations were programmed to transmit packets to the AP at a speed of 5 Mb/s and the uplink throughput performance between the long-range WiFi protocol described above and the conventional WiFi protocol was compared.

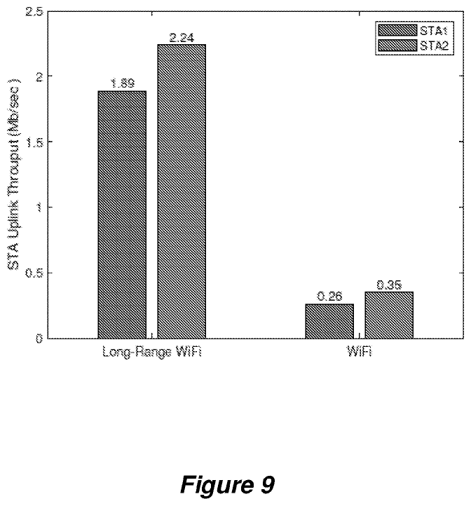

The result shown in FIG. 9. presents that in the conventional CSMA-based WiFi devices could only achieve a throughput of about 0.3 Mb/s. Compared with the conventional WiFi devices, the long-range WiFi device were observed to have a much higher throughput at approximately 2 Mb/s. This provides strong validation to the long-range WiFi protocol's ability to mitigate the hidden node issue.

An experiment was also conducted to investigate the presence of interference to test the reliability and latency on the MAC and Application layers. Four wireless devices were utilised with a timeslot duration set to 512 μs. The fixed transmission rate and retransmission times on the MAC layer were respectively set to 36 Mb/s and five. Three applications were developed to simulate RTB, NRT, and uplink traffic, respectively. All applications generated packets with a length of 50 bytes every 20 ms. A combination was executed of the three applications concurrently on the AP, with each experiment lasting 40 minutes.

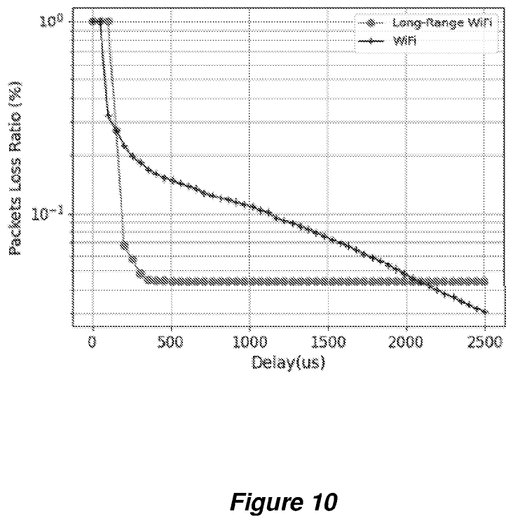

The MAC-layer result is shown with cumulative distribution function (CCDF) curves as FIGS. 9 and 10. The packets loss ratio in CCDF curves presents the percentage of the packets that are unsuccessful at or exceeding the given deadline.

FIG. 10 shows that the conventional WiFi outperforms the long-range WiFi when the latency is relatively low, presumably due to a fixed transmission rate and the aggregation mechanism described above, which leads to a longer packet transmission time. Also, the downward tendency of the long-range WiFi is concentrated upon the mean delay, while the curve of WiFi shows a gradual downward trend. This illustrates that the TDMA-based protocol also has the capability of bounded latency compared to the conventional WiFi. In the laboratory environment, WiFi can have a lower packet loss ratio than long-range WiFi due to the CSMA scheme. However, in the practical long-range scenario where the CSMA scheme fails to work, the reliability of WiFi will degrade significantly. The quantified result is shown in Table 1.

TABLE 1
Effective reliability with mac-layer latency lower
than a specific deadline value for four STAs

| | | | STA1 (%) | | STA2 (%) | | STA3 (%) | |
|---|---|---|---|---|---|---|---|---|
| | STA0 (%) | | Long- | | Long- | | Long- | |
| Timeout | Long-range | | range | | range | | range | |
| (ms) | WiFi | WiFi | WiFi | WiFi | WiFi | WiFi | WiFi | WiFi |
| 100 | 0 | 67.26 | 0 | 67.88 | 0 | 67.65 | 0 | 67.89 |
| 300 | 94.82 | 81.45 | 98.15 | 81.36 | 95.61 | 81.41 | 97.64 | 81.59 |
| 500 | 95.55 | 85.14 | 98.87 | 85.02 | 96.22 | 85.02 | 98.3 | 85.08 |
| 1000 | 95.57 | 89.07 | 98.89 | 88.94 | 96.23 | 88.99 | 98.32 | 88.98 |
| 1500 | 95.57 | 92.5 | 98.89 | 92.41 | 96.23 | 92.49 | 98.32 | 92.49 |
| 2000 | 95.57 | 95.19 | 98.89 | 95.18 | 96.23 | 95.23 | 98.32 | 95.19 |
| 2500 | 95.57 | 96.96 | 98.89 | 96.94 | 96.23 | 97.03 | 98.32 | 96.99 |

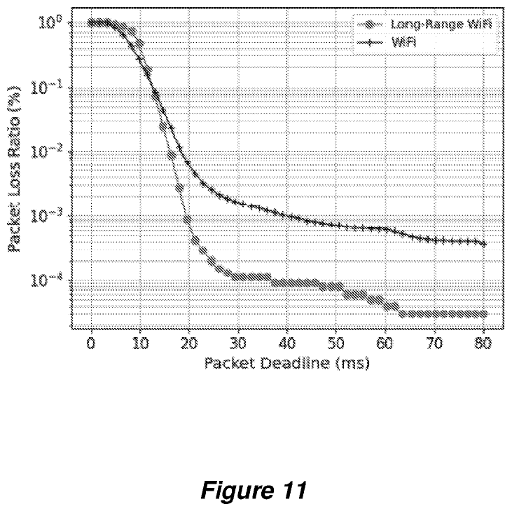

For the Application layer 132 performance, the curve of WiFi drops firstly and keeps a gradual downward tendency according to the result shown in FIG. 11. However, the long-range WiFi system starts to drop more quickly at the delay of 10 ms than WiFi and outperforms WiFi at the delay of 13 ms.

This supports the capability of bounded latency on the Application layer 132. With the Application layer retransmission described above, the achievable reliability is higher than the conventional WiFi. Similar to the MAC-layer result, the long-range WiFi system can still guarantee the Application-layer 132 performance in the long-range scenario, but the performance of conventional WiFi will decline significantly due to the hidden node issue. The quantified result is shown in Table 2.

TABLE 2
Effective reliability with app-layer latency lower
than a specific deadline value for four STAs

| | STA0 (%) | | | | | | | |
|---|---|---|---|---|---|---|---|---|
| | Long- | | STA1 (%) | | STA2 (%) | | STA3 (%) | |
| Timeout | range | | Long- | | Long- | | Long- | |
| (ms) | WiFi | WiFi | range WiFi | WiFi | range WiFi | WiFi | range WiFi | WiFi |
| 5 | 7.34 | 15.79 | 11.3 | 18.97 | 2.24 | 10.29 | 6.62 | 16.97 |
| 8 | 68.78 | 68.19 | 34.97 | 58.42 | 41.88 | 57.68 | 23.68 | 53.76 |
| 10 | 89.39 | 86.04 | 63.98 | 79.2 | 81.34 | 79.41 | 56.46 | 75.36 |
| 15 | 99.53 | 98.75 | 98.34 | 97.13 | 99.02 | 97.69 | 97.96 | 96.05 |
| 20 | 99.95 | 99.69 | 99.94 | 99.61 | 99.92 | 99.57 | 99.93 | 99.4 |
| 40 | 99.99 | 99.91 | 99.99 | 99.91 | 99.99 | 99.89 | 99.99 | 99.9 |
| 80 | 99.99 | 99.97 | 99.99 | 99.97 | 99.99 | 99.97 | 99.99 | 99.96 |

To validate the compatibility with convention WiFi devices, two setups were established; one long-range WiFi device and one conventional WiFi device. The first setup used the long-range AP, and the second used the conventional AP. The downlink performance at the two devices was measured using the method described above.

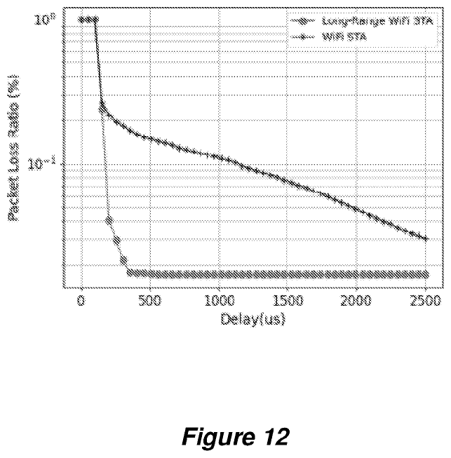

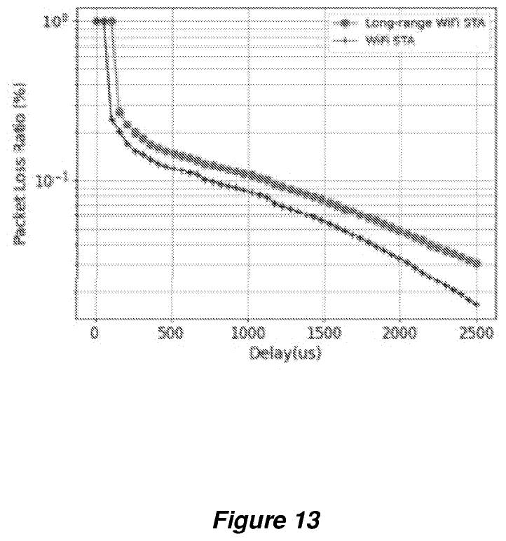

As shown in FIG. 12, the CCDF curve of the long-range WiFi drops faster than the conventional WiFi and concentrates on its average delay. In contrast, the curve of the conventional device follows a gradual downward tendency similar to the aforementioned MAC-layer result. However, the long-range device is observed to have a lower packet loss ratio, likely due to the TDMA scheduler avoiding transmission collisions between the uplink and downlink.

For the setup with the conventional AP, both devices follow a similar gradual downward tendency. The WiFi device can have slightly better reliability due to the CSMA scheme. It can be concluded that the long-range WiFi devices can normally communicate with existing WiFi devices without significant performance decline.

Field tests were also carried out with the long-range WiFi devices of the present disclosure in different environments—including underground mines and seashores. In particular, for the seashore environment, an omni-directional antenna with 5 dbi antenna gains was used and for the underground mining environment, directional panel antennas of 18 dbi and 20 degrees were used.

### Underground Mine Test

The achievable data rate and distance were measured in an underground tunnel having a line-of-sight distance of about ˜1.4 km. A long range AP with direction panel antenna was used. The AP had a pole height of about 1/6 m. Three types of wireless devices were tested in this environment—a device with long-range Wi-Fi protocol and directional antenna as described in the present disclosure, which was installed on a pole on a vehicle, a device with long-range Wi-Fi and omni-directional antenna as described in the present disclosure, and a normal WiFi device with legacy Wi-Fi protocol. It was found that all three devices could reach data rates over 1 Mbps at the distance of 1 km, and devices with the long-range Wi-Fi protocol of the present disclosure performed even better. The testing also demonstrated the compatibility of the presently disclosed WiFi system with existing Wi-Fi devices.

Table 3 shows the data rates in Mbps achieved for each of the three devices at different distances from the AP.

TABLE 3
Data rates (Mbps) for different devices at different
distances from the AP in an underground mine site

| | Distance (m) | | | | | | |
|---|---|---|---|---|---|---|---|
| Devices | 200 | 400 | 600 | 800 | 1000 | 1200 | 1400 |
| Long Range WiFi with | 28.3 | 28.3 | 26.93 | 27.67 | 27.53 | 28 | 12.2 |
| Panel Antenna | | | | | | | |
| Long Range WiFi with | 17.3 | 19 | 17.23 | 8.8 | 6.08 | 9.5 | 7.34 |
| Omni-directional | | | | | | | |
| Antenna | | | | | | | |
| Conventional WiFi | 11 | 8.2 | 6 | 5.5 | 3.9 | 1 | — |
| Device | | | | | | | |

As can be seen from the table, the proposed long-range WiFi device with the directional panel antenna had the highest data rates at all the different distances from the AP—achieving a data rate of 27.53 Mbps at 1 km as compared to the conventional WiFi device that achieved a data rate of 3.9 Mbps.

### Seashore Test

The presently disclosed long-range wireless devices and AP were also tested along a coastline to measure the performance of the system, the quality of the signal, and the achievable data rates over extremely long distances. A wireless device and an AP, both with the long-range Wi-Fi protocol and directional antennas of the present disclosure, were used. The directional antennas of both the wireless device and the AP were attached to poles at a height of about 3 m and the antennas were aligned.

Table 4 shows the average data rates (in Mbps) that were achieved at different distances (in kms) from the AP over three transmissions tests.

TABLE 4
Average data rates achieved at different distance from AP

| Distance (km) | 2 | 4 | 8 | 11 |
|---|---|---|---|---|
| Data Rate (Mbps) | 15 | 14.5 | 2.6 | <1 |
| Received signal strength | −70 | −72 | −80 | −89 |
| (dbm) | | | | |

The data rate is above 10 Mbps up to 4kms and reduces to 2.6 Mbps at the 8 km mark. The maximum distance with stable connection was determined to be about 11 km.

### Computer System

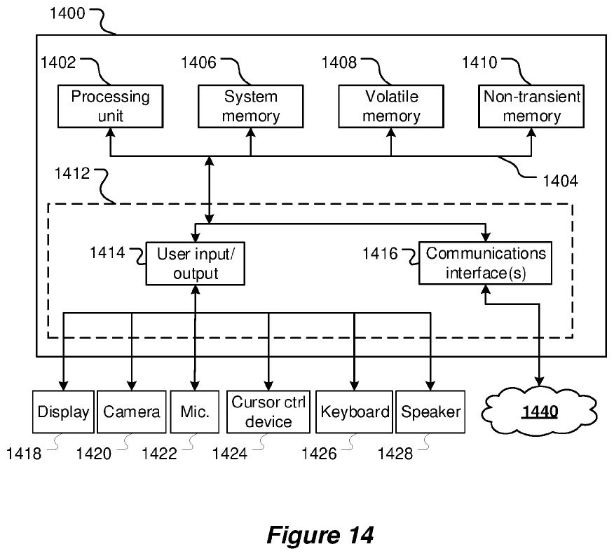

The techniques and operations described herein are performed by one or more computer processing systems, which is illustrated in FIG. 14. FIG. 14 provides a block diagram of a computer processing system 1400 configurable to implement embodiments and/or features described herein. System 1400 is a general purpose computer processing system. It will be appreciated that FIG. 14 does not illustrate all functional or physical components of a computer processing system. For example, no power supply or power supply interface has been depicted, however system 1400 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 1400 includes at least one processing unit 1402. The processing unit 1402 may be a single computer processing device (e.g. a central processing unit, graphics processing unit, or other computational device), or may include a plurality of computer processing devices.

Through a communications bus 1404 the processing unit 1402 is in data communication with a one or more machine readable storage (memory) devices which store computer readable instructions and/or data which are executed by the processing unit 1402 to control operation of the processing system 1400. In this example system 1400 includes a system memory 1406 (e.g. a BIOS), volatile memory 1408 (e.g. random access memory such as one or more DRAM modules), and non-transient memory 1410 (e.g. one or more hard disk or solid state drives).

System 1400 also includes one or more interfaces, indicated generally by 1412, via which system 1400 interfaces with various devices and/or networks. Generally speaking. other devices may be integral with system 1400, or may be separate. Where a device is separate from system 1400, connection between the device and system 1400 may be via wired or wireless hardware and communication protocols, and may be a direct or an indirect (e.g. networked) connection.

Wired connection with other devices/networks may be by any appropriate standard or proprietary hardware and connectivity protocols. For example, particularly when system 1400 is an AP, system may be configured for wired connection with other devices/communications networks by one or more of: USB; eSATA; Ethernet; HDMI; and/or other wired connections.

Wireless connection with other devices/networks may similarly be by any appropriate standard or proprietary hardware and communications protocols. For example, system 1400 may be configured for wireless connection with other devices/communications networks using one or more of: BlueTooth; WiFi; near field communications (NFC); Global System for Mobile Communications (GSM). and/or other wireless connections.

Generally speaking, and depending on the particular system in question. devices to which system 1400 connects—whether by wired or wireless means—include one or more input devices to allow data to be input into/received by system 1400 and one or more output device to allow data to be output by system 1400. Example devices are described below, however it will be appreciated that not all computer processing systems will include all mentioned devices, and that additional and alternative devices to those mentioned may well be used.

For example, system 1400 may include or connect to one or more input devices by which information/data is input into (received by) system 1400. Such input devices may include keyboard, mouse, trackpad, microphone, accelerometer, proximity sensor, GPS, and/or other input devices. System 1400 may also include or connect to one or more output devices controlled by system 1400 to output information. Such output devices may include devices such as a display (e.g. a LCD, LED, touch screen, or other display device), speaker, vibration module, LEDs. other lights, and/or other output devices. System 1400 may also include or connect to devices which may act as both input and output devices, for example memory devices (hard drives, solid state drives, disk drives, and/or other memory devices) which system 1400 can read data from and/or write data to, and touch screen displays which can both display (output) data and receive touch signals (input).

By way of example. where system 1400 is a wireless device 130 it usually includes a display 1418 (which may be a touch screen display), a camera device 1420, a microphone device 1422 (which may be integrated with the camera device), a cursor control device 1424 (e.g. a mouse, trackpad, or other cursor control device), a keyboard 1426, and a speaker device 1428.

System 1400 also includes one or more communications interfaces 1416 for communication with a network, such as the WiFi network described above. Via the communications interface(s) 1416, system 1400 can communicate data to and receive data from networked systems and/or devices.

System 1400 stores or has access to computer applications (also referred to as software or programs)—i.e. computer readable instructions and data which, when executed by the processing unit 1402, configure system 1400 to receive, process, and output data. Instructions and data can be stored on non-transient machine readable medium such as 1410 accessible to system 1400. Instructions and data may be transmitted to/received by system 1400 via a data signal in a transmission channel enabled (for example) by a wired or wireless network connection over an interface such as communications interface 1416.

Typically, one application accessible to system 1400 will be an operating system application. In addition, system 1400 will store or have access to applications which, when executed by the processing unit 1402, configure system 1400 to perform various computer-implemented processing operations described herein.

It will be understood that the invention disclosed and defined in this specification extends to all alternative combinations of two or more of the individual features mentioned or evident from the text or drawings. All of these different combinations constitute various alternative aspects of the invention.

1. A wireless device comprising:
a communication processor;
WiFi hardware operable to access a WiFi communication channel; and
a computer-readable medium storing instructions, which when executed by the communications processor, cause the communication processor to:
execute, in a MAC layer of a communication protocol stack, a channel-access scheduler that controls the WiFi hardware to access the WiFi communication channel by way of a TDMA channel-access method.

2. The wireless device of claim 1, wherein the channel-access scheduler operates according to scheduling instructions, the scheduling instructions defined in a network data unit received by the wireless device over the WiFi communication channel.

3. The wireless device of any one of claim 1 or 2, wherein the instructions further cause the communication processor to:
transmit a packet during a communication time slot allocated to the wireless device by the channel-access scheduler;
determine whether an acknowledgment packet is received at the wireless device within a predetermined time; and
in the absence of receipt of an acknowledgement packet within a predetermined time, retransmitting the packet during two or more communication time slots allocated to the wireless device by the channel-access scheduler.

4. The wireless device of any one of claims 1-3, wherein the instructions further cause the communication processor to:
receive two or more frames over the WiFi communication channel;
aggregate the received frames into an aggregated frame; and
transmit the aggregated frame over the WiFi communication channel to multiple stations using a broadcast address.

5. The wireless device of claim 4, wherein the communication processor is configured to aggregate the received frames by:
utilising the destination address of a first frame as the broadcast address;
appending an aggregation identifier to the broadcast address;
appending a first station flag to the aggregation identifier;
appending the first frame to the aggregation identifier; and
appending a second station flag to the first frame; and appending a second frame to the second station flag.

6. The wireless device of any one of claims 1-3, wherein the instructions further cause the communication processor to:
parse a frame received at the wireless device;
determine whether the frame is an aggregated frame; and
in the event that the frame is an aggregated frame, de-aggregate the aggregated frame.

7. The wireless device of claim 6, wherein the communications processor determines whether the frame is an aggregated frame by parsing the frame for a broadcast address and an aggregation identifier.

8. The wireless device of claim 6, wherein communication processor is configured to de-aggregate the aggregated frame by identifying a network address in the frame and discarding the remainder of the frame after the network address.

9. The wireless device of any one of claims 1-8, wherein the instructions further cause the communications processor to apply a restricted access mechanism in which the wireless device accesses the TDMA wireless communication channel only during a restricted access window.

10. The wireless device of claim 9, wherein the instructions further cause the communications processor to allow the wireless device to access a CSMA wireless communication network during times outside the restricted access window.

11. A method executable on a WiFi access point, the method comprising:
executing, in a MAC layer of a communication protocol stack installed on the WiFi access point, a channel-access scheduler that controls the WiFi access point to access the WiFi communication channel by way of a TDMA channel-access method.

12. The method of claim 11, wherein the WiFi access point is operably connected to a directional antenna, the channel-access scheduler controlling the WiFi access point to access the WiFi communication channel using the directional antenna.

13. The method of claim 11 or 12, wherein the channel-access scheduler operates according to scheduling instructions, the scheduling instructions generated by the WiFi access point or received by the WiFi access point over the WiFi communication channel.

14. The method of any one of claims 11-13, further including:
transmitting a packet during a communication time slot allocated to the WiFi access point by the channel-access scheduler;
determining whether an acknowledgment packet is received at the WiFi access point within a predetermined time; and
in the absence of receipt of an acknowledgement packet within a predetermined time, retransmitting the packet during two or more communication time slots allocated to the WiFi access point by the channel-access scheduler.

15. The method of any one of claims 11-13, further including:
receiving two or more frames over the WiFi communication channel;
aggregating the received frames into an aggregated frame; and
transmitting the aggregated frame over the WiFi communication channel to multiple stations using a broadcast address.

16. The method of claim 15, wherein aggregating the received frames into the aggregated frame includes:
utilising the destination address of a first frame as the broadcast address;
appending an aggregation identifier to the broadcast address;
appending a first station flag to the aggregation identifier;
appending the first frame to the aggregation identifier;
appending a second station flag to the first frame; and
appending a second frame to the second station flag.

17. The method of any one of claims 11-14, further including:
parsing a frame received at the WiFi access point;
determining whether the frame is an aggregated frame; and
in the event that the frame is an aggregated frame, de-aggregating the aggregated frame.

18. The method of claim 17, wherein determining whether the frame is an aggregated frame includes:
parsing the frame for a broadcast address and an aggregation identifier.

19. The method of claim 17, where in de-aggregating the aggregated frame includes:
identifying a network address in the frame; and
discarding the remainder of the frame after the network address.

20. The method of any one of claims 11-19 further including:
applying a restricted access mechanism in which wireless devices are permitted to access the TDMA wireless communication network only during a restricted access window.

21. The method of claim 20, further including: permitting wireless devices to access a CSMA wireless communication network during times outside the restricted access window.

22. A computer readable medium storing instructions, which when executed by a communication processor, cause the communication processor to execute, in a MAC layer of a communication protocol stack, a channel-access scheduler that controls WiFi hardware to access a WiFi communication channel by way of a TDMA channel-access method.

23. The computer readable medium of claim 22, storing instructions that further cause the communication processor to:
transmit a packet during a communication time slot allocated to the wireless device by the channel-access scheduler;
determine whether an acknowledgment packet is received at the wireless device within a predetermined time; and
in the absence of receipt of an acknowledgement packet within a predetermined time, retransmitting the packet during two or more communication time slots allocated to the wireless device by the channel-access scheduler.

24. The computer readable medium of claim 22, further storing instructions that further cause the communication processor to:
receive two or more frames over the WiFi communication channel;
aggregate the received frames into an aggregated frame; and
transmit the aggregated frame over the WiFi communication channel to multiple stations using a broadcast address.

25. The computer readable medium of claim 24, wherein the communication processor aggregates the received frames by:
utilising the destination address of a first frame as the broadcast address;
appending an aggregation identifier to the broadcast address;
appending a first station flag to the aggregation identifier;
appending the first frame to the aggregation identifier;
appending a second station flag to the first frame; and
appending a second frame to the second station flag.

26. The computer readable medium of any one of claims 22-25, further storing instructions that cause the communication processor to:
parse a frame received at the wireless device;
determine whether the frame is an aggregated frame; and
in the event that the frame is an aggregated frame, de-aggregate the aggregated frame.

27. The computer readable medium of claim 26, wherein the communications processor determines whether the frame is an aggregated frame by parsing the frame for a broadcast address and an aggregation identifier.

28. The computer readable medium of claim 26, wherein the communication processor de-aggregates the aggregated frame by identifying a network address in the frame and discarding the remainder of the frame after the network address.

29. The computer readable medium of any one of claims 22-28, further storing instructions that cause the communications processor to apply a restricted access mechanism in which wireless devices are permitted to access the TDMA WiFi communication channel only during a restricted access window.

30. The computer readable medium of claim 29, further storing instructions that cause the communications processor to allow wireless devices to access a CSMA WiFi communication channel during times outside the restricted access window.

31. A long range WiFi network, comprising:
a WiFi access point configured to carry out the method according to any one of claims 11-21;
a directional antenna communicatively coupled to the WiFi access point; and
one or more wireless devices each including the computer readable medium according to any one of claims 22-30.
